(19) United States
(12) Patent Application Publication
(10) Pub. No.: US 2006/0183020 A1
(43) Pub. Date: Aug. 17, 2006

(54) Sealing assembly for electrochemical cell

(75) Inventors: Gregory J. Davidson, Oregon, WI (US); Viet Vu, Verona, WI (US); Tom Kaufman, Middleton, WI (US); Karthik Ramaswami, Middleton, WI (US)

Correspondence Address: SENNIGER POWERS, ONE METROPOLITAN SQUARE, 16TH FLOOR, ST LOUIS, MO, 63102, US

(73) Assignee: Rovcal, Inc., Madison, WI (US)

(21) Appl. No.: 11/058,678

(22) Filed: Feb. 15, 2005

(51) Int. Cl. H01M 2/08

(52) U.S. Cl. 429/174; 29/623.2; 429/165; 429/172

(57) ABSTRACT

In an electrochemical cell a container houses a cathode, an anode, a separator between the cathode and the anode, a negative current collector and a sealing assembly for sealing a terminal end of the separator extending outward from between the cathode and the anode. The sealing assembly seals the terminal end of the separator between a first sealing member in sealing relationship with the first face of the separator terminal end and a second sealing member in sealing relationship with the second face of the separator terminal end. In another embodiment, the sealing assembly seals the terminal end of the separator between the sealing assembly in sealing relationship with the first face of the separator terminal end and at least one of the cathode, the anode and the container in sealing relationship with the second face of the separator terminal end.

### BACKGROUND

This invention relates generally to electrochemical cells such as batteries, and more particularly to a sealing assembly for inhibiting contamination between positive electrode (e.g., cathode) materials and negative electrode (e.g., anode) materials within an electrochemical cell.

The present invention has particular application to electrochemical cells, such as in the form of elongate cylindrical cells (e.g., AA, AAA, C and D-size batteries), relatively flat cells (e.g., prismatic cells and button cells), and rounded flat cells (e.g., having a racetrack cross-section). As one example, primary alkaline electrochemical cells typically comprise a centrally disposed anode (i.e., a negative electrode) surrounded by an elongate annular cathode (i.e., a positive electrode). The anode and cathode are disposed in close, but physically spaced relation with each other within a metal container (which serves as a positive current collector) having an open top end. A tubular separator (also sometimes referred to as an anode container) is formed as a cup to hold the anode material and physically separates the anode and cathode within the metal container.

The cathode of conventional alkaline electrochemical cells is constructed of manganese dioxide, a conducting carbonaceous material, typically synthetic, natural or expanded graphite or mixtures thereof, and a binder such as polyethylene powder in a mixture wetted with an aqueous alkaline electrolyte such as potassium hydroxide. Other cells may have a cathode comprising NiOOH, an oxide of copper or other mixture of cathode active materials. In cylindrical cells, the cathode mixture is compressed into one or more annular rings and stacked in the metal container, or the mixture may be extruded directly into the metal container.

The anode may conventionally comprise zinc or zinc alloy particles disposed in an alkaline electrolyte, such as potassium hydroxide, along with gelling agents such as carboxymethylcellulose (CMC) or a salt of polyacrylic acid (e.g., Carbopol 934) together with other additives such as surfactants. The separator between the cathode and anode enables ions, but not electrons, to transfer therebetween while preventing the cathode and anode materials from directly contacting each other and creating an electrical short circuit or otherwise negatively effecting operation or shelf life of the cell.

Electrical connection to the anode is achieved by inserting an elongate metal rod or wire, commonly referred to as a negative current collector or nail, into the anode. The current collector may be made of brass or other suitable metal and extends through a resilient and electrically nonconductive gasket that closes the open end of the container, sealing the anode and cathode materials within the container. A top end of the current collector protrudes above the gasket for physical and electrical connection to an electrically conductive negative terminal plate, while the primary length of the collector below the gasket is inserted into the anode material. The gasket seals the collector at the gasket hub, through which the collector extends, to inhibit anode material from passing out through the gasket.

The separator conventionally extends from the bottom of the metal container to a terminal end extending slightly outward from between the anode and the cathode, particularly prior to the cell being closed. Upon closing the cell, the gasket contacts and pushes down against the terminal end of the separator, often causing the terminal end of the separator to generally fold or bend so that one side of the terminal end of the separator generally faces and abuts against the gasket to inhibit electrolyte or particulate material (e.g., the electrode materials) against leaking or being carried over the terminal end of the separator between the anode and cathode compartments.

Commercial alkaline batteries generally have separators comprised of multiple layers of woven or non-woven materials, with each layer ranging in dry thickness from about 40 microns (micrometers) to about 75 microns. The total wall thickness of the separator can range from 160 microns up to about 300 microns. When electrolyte is introduced into the cell, a significant amount of the electrolyte is absorbed into the separator which then swells. In the finished cell, the separator thus holds and provides a reservoir of electrolyte between the anode and the cathode, which is beneficial to discharge performance.

In a typical cell assembly operation, after insertion of the separator into the cathode cavity, a measured amount of electrolyte is introduced such that the separator absorbs this electrolyte and wicks part of it into the cathode mass so as to provide the cathode with adequate electrolyte for its discharge. The anode is next introduced into the cavity formed by the annular cathode. The gasket and collector are together inserted into the open end of the cell and then the cell is closed. The wet strength of the separator is an important characteristic in achieving a good seal with the gasket. The multiple layers and relatively high thickness of the separator provide sufficient separator wall strength to maintain its general shape following compression by the gasket upon closing the cell and upon wetting (e.g., by electrolyte) of the separator. In particular, the relatively thick separator wall possesses adequate longitudinal wet strength to provide a satisfactory physical seal at the separator-to-gasket interface when the gasket pushes down on the terminal end of the separator during cell closing. Maintaining the wall strength of the separator is thus important to inhibit leakage of the anode material over the terminal end of the separator into contact with the cathode material of conventional cells, or vice-versa.

However, providing a sufficiently thick separator takes up space within the cell and thus compromises the quantity of active materials that can be incorporated in the cell. As long as adequate electrolyte is available in the cell, the quantity of active materials and the efficiency of their discharge determine the service life of the cell. Excessive volume occupied by the separator therefore limits the service life improvements that can otherwise be made by increasing the quantity of active material within the cell. The ever-increasing demand for batteries with longer service life necessitates more efficient utilization of the internal volume of the container.

Thus, reducing the volume occupied by the separator, e.g., by decreasing the separator wall thickness, offers an opportunity for increased service life. However, as the separator wall is made thinner, its wet strength decreases, thereby compromising the reliability of cells having the conventional gasket/separator arrangement against internal shorting. There is a need, therefore, for a sealing assembly suitable for more actively sealing the terminal end of a thin walled separator.

### SUMMARY

An electrochemical cell according to one embodiment generally comprises a cathode, an anode and a container having a sidewall defining an interior of the container. The cathode and the anode are disposed in the container, with the container defining a longitudinal direction and a transverse direction of the cell. A separator is disposed in the container between the cathode and the anode and has a terminal end extending longitudinally outward from between the cathode and the anode. The terminal end of the separator has a first face and a second face opposite the first face. A negative current collector is also disposed in the container and is in contact with the anode. A sealing assembly for sealing the terminal end of the separator is formed separate from the cathode, the anode and the container and comprises a first sealing member in sealing relationship with the first face of the terminal end of the separator and a second sealing member in sealing relationship with the second face of the terminal end of the separator to thereby seal the terminal end of the separator.

In another embodiment, an electrochemical cell generally comprises a cathode, an anode and a container having a sidewall defining an interior of the container. The cathode and the anode are disposed in the container, with the container defining a longitudinal direction and a transverse direction of the cell. A separator is disposed in the container between the cathode and the anode and has a terminal end extending longitudinally outward from between the cathode and the anode. The terminal end of the separator has a first face and a second face opposite the first face. A negative current collector is also disposed in the container and is in contact with the anode. A sealing assembly for sealing the terminal end of the separator is configured and arranged within the container to seal the terminal end of the separator between the sealing assembly and at least one of the cathode, the anode and the container with the first face of the terminal end of the separator in sealing relationship with the sealing assembly and the second face of the terminal end of the separator in sealing relationship with at least one of the cathode, the anode and the container.

In yet another embodiment, an electrochemical cell generally comprises a generally cylindrical container having a sidewall defining an interior of the container. The container further defines a longitudinal direction and a radial direction of the cell. A generally annular cathode extends longitudinally within the container and a tubular separator extends longitudinally within the cathode to define an interior thereof. An anode is disposed within the interior of the separator such that the separator separates the cathode from the anode, the separator having a terminal end extending out from between the cathode and the anode, a radially inner face and a radially outer face opposite the inner face. A negative current collector is disposed in the container in contact with the anode. A sealing assembly for sealing the terminal end of the separator pinches the inner and outer faces of the terminal end of the separator between at least a portion of the sealing assembly and at least one of another portion of the sealing assembly, the anode, the cathode and the container sidewall.

In general, a method for making an electrochemical cell comprises inserting a cathode into a container, configuring a separator to define an interior thereof for receiving an anode, and inserting the anode into the interior of the separator. The anode fills less than the entire interior of the separator to define a terminal end of the separator that is unfilled by the anode and has a first face and a second face opposite the first face. A sealing assembly is positioned at the terminal end of the separator to seal the terminal end whereby the sealing assembly, the separator and the anode are held in assembly with each other for insertion into the container. The sealing assembly, separator and anode are inserted into the container with the separator separating the anode from the cathode and the terminal end of the separator extending out from between the anode and cathode and sealed by the sealing assembly.

### BRIEF DESCRIPTION OF THE DRAWINGS

FIG. 1 illustrates a cross-section of an electrochemical cell having a sealing assembly according to one embodiment of the present invention, with a container of the electrochemical cell illustrated in an open configuration to facilitate assembly of the cell;

FIG. 1A illustrates an enlarged, fragmented view of the electrochemical cell of FIG. 1;

FIG. 2 illustrates an enlarged, fragemented view of the electrochemical cell of FIG. 1 with the container illustrated in a closed configuration;

FIG. 3 illustrates a perspective view of the sealing assembly of the electrochemical cell of FIG. 1;

FIG. 4 illustrates a fragmented cross-section of an electrochemical cell having a sealing assembly according to a second embodiment of the present invention, with a container of the cell illustrated in an open configuration;

FIG. 5 illustrates a view similar to FIG. 4 with the container in a closed configuration;

FIG. 6 illustrates a fragmented cross-section of an electrochemical cell having a sealing assembly according to a third embodiment of the present invention, with a container of the cell illustrated in an open configuration;

FIG. 7 illustrates a view similar to FIG. 6 with the container in a closed configuration;

FIG. 8 illustrates a fragmented cross-section of an electrochemical cell having a sealing assembly according to a fourth embodiment of the present invention, with a container of the cell illustrated in an open configuration;

FIG. 9 illustrates a view similar to FIG. 8 with the container in a closed configuration;

FIG. 10 illustrates a fragmented cross-section of an electrochemical cell having a sealing assembly according to a fifth embodiment of the present invention, with a container of the cell illustrated in an open configuration;

FIG. 11 illustrates a view similar to FIG. 10 with the container in a closed configuration;

FIG. 12 illustrates a fragmented cross-section of an electrochemical cell having a sealing assembly according to a sixth embodiment of the present invention, with a container of the cell illustrated in an open configuration;

FIG. 13 illustrates a view similar to FIG. 12 with the container in a closed configuration;

FIG. 14 illustrates a fragmented cross-section of an electrochemical cell having a sealing assembly according to a seventh embodiment of the present invention, with a container of the cell illustrated in a closed configuration;

FIG. 15 illustrates a fragmented cross-section of an electrochemical cell having a sealing assembly according to an eighth embodiment of the present invention, with a container of the cell illustrated in a closed configuration;

FIG. 16 illustrates a fragmented cross-section of an electrochemical cell having a sealing assembly according to a ninth embodiment of the present invention, with a container of the cell illustrated in an open configuration;

FIG. 17 illustrates a view similar to FIG. 16 with the container in a closed configuration;

FIG. 18 illustrates a fragmented cross-section of an electrochemical cell having a sealing assembly according to a tenth embodiment of the present invention, with a container of the cell illustrated in an open configuration;

FIG. 19 illustrates a view similar to FIG. 18 with the container in a closed configuration;

FIG. 20 illustrates a fragmented cross-section of an electrochemical cell having a sealing assembly according to an eleventh embodiment of the present invention, with a container of the cell illustrated in an open configuration;

FIG. 21 illustrates a fragmented cross-section of an electrochemical cell having a sealing assembly according to a twelfth embodiment of the present invention, with a container of the cell illustrated in an open configuration; and

FIG. 22 illustrates a fragmented cross-section of an electrochemical cell having a sealing assembly according to a thirteenth embodiment of the present invention, with a container of the cell illustrated in an open configuration.

Corresponding reference characters indicate corresponding parts throughout the several views of the drawings.

### DESCRIPTION

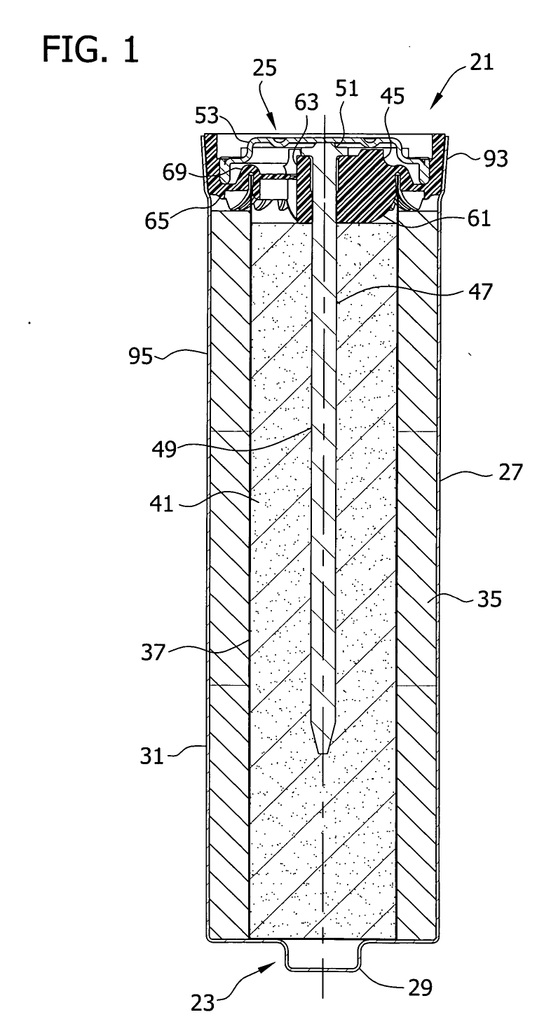

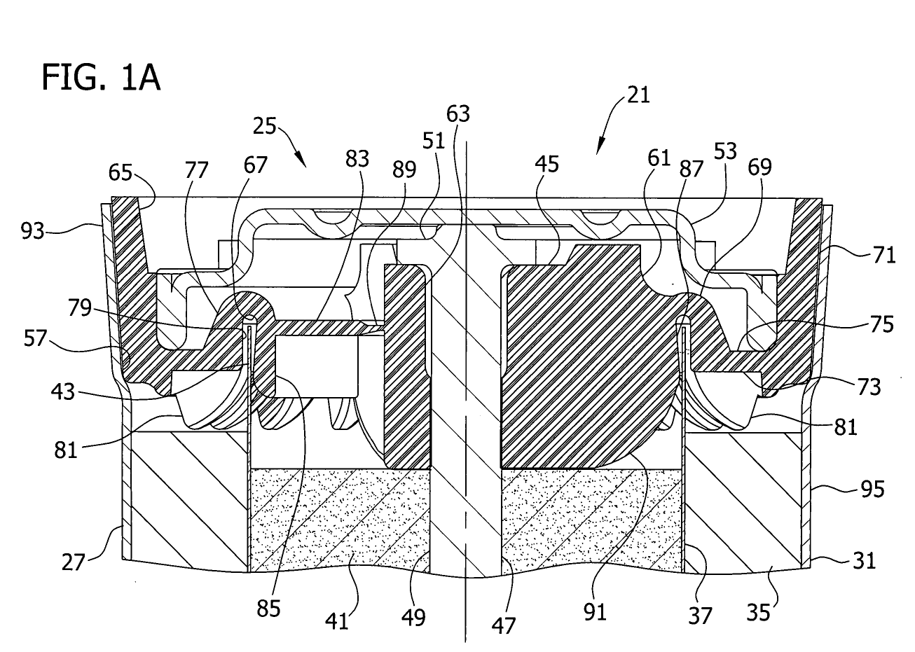

Referring now to the drawings, and in particular to FIGS. 1 and 1A, an electrochemical cell having a sealing assembly constructed in accordance with one embodiment of the present invention is shown in the form of a AA-size cylindrical cell battery and is generally indicated at 21. It is contemplated, however, that the sealing assembly of the present invention has application to other sized batteries (e.g., A, AAA, C and D), as well as to non-cylindrical cells, such as flat cells (e.g., prismatic cells and button cells) and rounded flat cells (e.g., having a racetrack cross-section). The cylindrical cell 21 configuration shown in FIG. 1 has a positive terminal 23, a negative terminal 25, and a positive current collector in the form of an electrically conductive cylindrical container 27. In the illustrated embodiment, the container 27 is drawn steel having a closed bottom formed by an end wall 29 and a cylindrical side wall 31 formed as one piece with the end wall. The positive terminal 23 of the cell 21 is thus defined by the end wall 29 of the metal container 27 in the illustrated embodiment. In alternative embodiments, the end wall may be flat and have a positive terminal plate (not shown) attached thereto as by welding to define the positive terminal 23 of the cell 21 without departing from the scope of this invention. The opposite end of the container 27 is generally open.

As used herein the term “side wall” refers not only to a wall like the illustrated cylindrical wall 31 having a single, continuous curve, but also to side walls (not shown) having other shapes including those formed from multiple flat wall sections. The term “longitudinal”, as used herein, refers to the direction extending from one end of the container 27 to the other, regardless of whether the greatest dimension of the container is in the longitudinal direction. The terms “lateral,” “transverse” and “radial” refer to a direction extending perpendicular to the longitudinal direction so as to extend through the side wall 31 of the container 27. In particular, where the term radial is used herein in reference to annular or circular shaped elements, it is understood that the terms lateral and transverse may be substituted for the radial for components that are other than annular or circular.

Also, throughout the various drawings the electrochemical cells are illustrated in a generally vertical orientation, with the positive terminal 23 at the bottom and the negative terminal 25 at the top. It is to be understood that the use of terms herein such as top, bottom, upper and lower, are in reference to cell orientations shown in the drawings and intended as references to positions along the longitudinal direction of the cell 21 (e.g., of the container 27), while the use of terms such as inner and outer are in reference to positions along the transverse or radial direction.

A cathode 35 comprised of one or more annular rings (three are shown in the illustrated embodiment of FIG. 1) formed of a suitable cathode material is located in the metal container 27 and defines an open center along the longitudinal direction of the container. The cathode 35 may have an outer diameter that is slightly greater than the inner diameter of the metal container side wall 31 to provide a tight fit upon insertion of the cathode into the container. In other embodiments, the cathode 35 may alternatively be consolidated against the metal container 27 to provide intimate contact between the cathode and the container side wall 31. A coating, suitably carbon, may be applied to the inner surface of the container side wall 31 to enhance electrical contact between the cathode 35 and the container. In one particularly suitable embodiment, the cathode 35 is constructed of an oxide of copper by itself or in combination with other known cathode active materials as disclosed in co-assigned U.S. patent application Ser. No. 10/914,958, the entire disclosure of which is incorporated herein by reference. It is understood, however, that the cathode 35 may be constructed of manganese dioxide or other suitable cathode materials without departing from the scope of this invention.

A tubular separator 37 is located on the inner diameter of the cathode 35. In a particularly suitable embodiment, the separator 37 has a wall thickness of less than or equal to about 0.01 inches (about 0.254 mm). For example, one suitable separator 37 is disclosed in co-assigned U.S. patent application Ser. No. 10/914,934, which is incorporated herein by reference, and comprises a relatively thin film having a thickness of less than or equal to about 0.01 inches (about 0.254 mm). It is contemplated that the separator film can more suitably have a thickness in the range of about 0.0002 inches (about 0.005 mm) to about 0.001 inches (about 0.025 mm). However, it is understood that the separator 37 may instead be constructed of a paper material, a fibrous non-woven web or other suitable separator material, and may have a wall thickness of greater than about 0.01 inches (about 0.254 mm), without departing from the scope of this invention. The separator illustrated in FIG. 1 has a closed end, such as by sealing the sidewall of the separator together at its bottom, in opposed relationship with the end wall 29 of the container 27. However, it is contemplated that the separator need not have a closed end to remain within the scope of this invention. For example, a bottom cup (not shown) may be inserted into the tubular separator to close an open bottom end of the separator. Alternatively, a bottom cup (not shown) may be inserted first into the cathode, followed by insertion of the open-ended separator tube into the bottom cup. Thus it will be understood that the separator may be suitably formed exterior of the cathode and then subsequently inserted into the cathode, or may be formed in-situ within the cathode.

An anode 41 is located on the inner diameter of the separator 37 so that the separator physically separates the anode from the cathode 35. The anode 41 can be formed in any suitable manner, and may suitably comprise a mixture including an anode metal (e.g., zinc) provided as a powder, an aqueous alkaline electrolyte and a gelling agent. Examples of suitable anode 41 formulations are discussed in co-assigned U.S. Pat. No. 6,040,088, the entire disclosure of which is incorporated herein by reference. Another particularly suitable anode 41 formulation is disclosed in co-assigned U.S. patent application Ser. No. 10/914,911, the entire disclosure of which is incorporated herein by reference. Additional electrolyte (not shown) may be added to the container 27 to partially wet the anode 41, the cathode 35 and the separator 37. Suitable electrolytes include potassium hydroxide and sodium hydroxide in an alkaline battery, but other compositions can be used without departing from the scope of the present invention.

The separator 37 of the illustrated embodiment extends longitudinally within the container 27 from the end wall 29 of the container to a terminal end 43 (FIG. 1A) extending out from between the anode and cathode toward the open end of the container. A gasket 45 for sealing the open end of the container 27 is shown supported by the container generally at the negative (e.g., upper, or open) end thereof and holding a negative current collector (indicated generally at 47) or nail that is partially received in the anode 41. The negative current collector 47 is made of a suitable metal such as brass, zinc, zinc alloys or tin plated brass. The negative current collector 47 has a shank 49 and a head 51 at the upper (e.g., open) end of the container 27 that is attached as by welding to a negative terminal plate 53.

While not shown in the drawings, a washer may be located between the negative terminal plate 53 and the gasket 45 to facilitate sealing contact of the gasket with the inner surface of the metal container side wall 31. The washer may be suitably made of an electrically conductive material such as galvanized carbon steel.

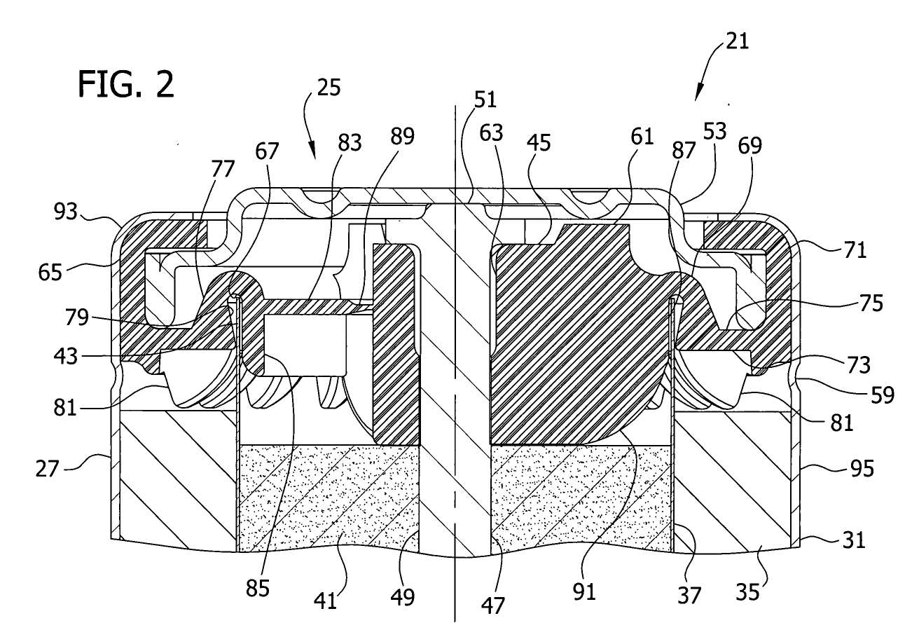

FIGS. 1 and 1A particularly illustrate the cell 21 during initial assembly, with the container 27 in what is referred to herein as an open configuration of the container in which the container sidewall flares outward toward its upper end to define a shoulder 57 for longitudinally locating the gasket 45 upon insertion of the gasket into the container. An upper extent 93 of the container side wall 31 extends above the shoulder 57 and has an inner diameter slightly greater than the inner diameter of a lower extent 95 of the container side wall extending below the shoulder to the end wall 29 of the container 27. The inner diameter of the lower extent 95 of the container side wall 31 suitably corresponds to the inner diameter of the upper and lower extents 93, 95 of the container side wall of the fully assembled cell 21 as illustrated in FIG. 2 in what is referred to herein as a closed configuration of the container. Upon closing the container 27, an annular groove 59 (FIG. 2) is formed in the container as a result of the shoulder 57 having been initially formed in the open configuration of the container. It is contemplated that the annular groove 59 may be formed in the container by other suitable processes, or the groove may be omitted from the closed container, without departing from the scope of the invention.

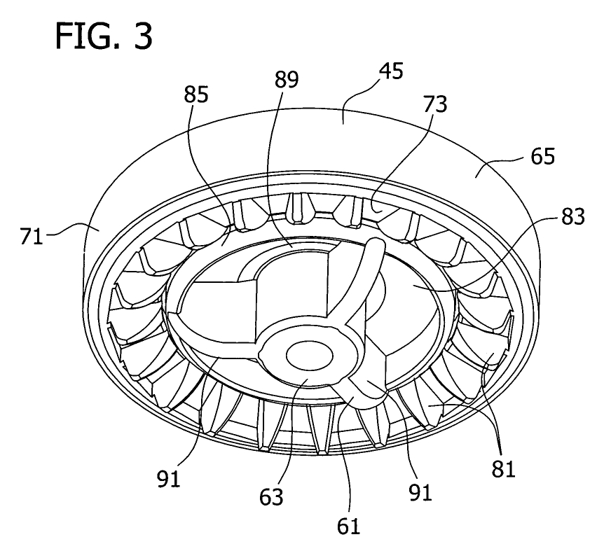

With additional reference to FIGS. 2 and 3, the gasket 45 of the illustrated embodiment broadly defines a sealing assembly constructed in accordance with one embodiment of the present invention for substantially sealing the terminal end 43 of the separator 37 to inhibit contamination between the anode and the cathode. The gasket 45 is generally disk-shaped and comprises an annular radially inner portion 61 (broadly, a first sealing member of the sealing assembly) including a central hub 63 through which the negative current collector 47 extends, an annular radially outer portion 65 (broadly, a second sealing member of the sealing assembly) spaced from the inner portion to define a slot 67 therebetween, and an annular web 69 extending radially between and generally hingedly connecting the inner and outer portions at the slot to permit folding of the gasket generally at the web for purposes that will become apparent.

As illustrated, the gasket 45 (and hence, broadly, the sealing assembly of the illustrated embodiment) is of a single-piece construction. For example, the gasket 45 may be molded of nylon 6,6 which has been found to be inert to the electrolyte (e.g., potassium hydroxide) contained in the metal container 27, and yet also sufficiently deformable upon compression to function as a seal against the side wall 31 of the container. It is contemplated that the gasket 45 may alternatively be formed of other suitable materials, including without limitation polyolefin, polysulfone, polypropylene, filled polypropylene (e.g., talc-filled polypropylene), sulfonated polyethylene, polystyrene, impact-modified polystyrene, glass filled nylon, ethylene-tetrafluoroethylene copolymer, high density polypropylene and other plastic materials. One particular example of a suitable glass filled nylon material for use in forming the gasket 45 is disclosed in co-assigned U.S. Published Application No. 2004/0145344 filed Oct. 27, 2003, the disclosure of which is incorporated herein by reference to the extent that it is consistent.

The outer portion 65 of the gasket 45 is generally L-shaped in cross section with a radially outer vertical leg 71 of the “L” facing the interior of the container side wall 31 upon assembly of the cell 21. A horizontal leg 73 of the “L” forms an annular shoulder 75 on which negative terminal plate 53 is seated. The outer portion 65 of the gasket 45 also has a radially inner vertical leg 77 extending vertically (e.g., longitudinally) up from the annular shoulder 75 to define an outer face 79 of the slot 67 formed in the gasket. As best seen in FIG. 3, a plurality of guide members 81 are integrally formed with and depend from the outer portion 65 of the gasket 45 in spaced relationship with each other about the gasket. The guide members 81 are configured to taper up and in toward the outer face 79 of the slot 67 formed in the gasket 45, generally at the entry of the slot formed in the gasket, to facilitate guidance of the terminal end 43 of the separator 37 into the slot upon initial assembly of the cell 21 as will be described.

The inner portion 61 of the gasket 45 comprises the central hub 63 (for receiving the current collector therethrough), a generally annular horizontal leg 83 extending radially out from the central hub, and an annular vertical leg 85 secured to the radially outer end of the horizontal leg and defining an inner face 87 of the slot 67 in opposed relationship with the outer face 79 defined by the outer portion 65 of the gasket. It is possible for chemical reactions taking place in the container 27 of the cell 21 to produce a gas as a product of the reactions. Gas production can cause an increase in pressure within the metal container 27 to the point where the upper extent 93 of the container sidewall 31 is urged open and the gasket 45 may spontaneously disassemble from the container. To avoid this undesirable result, the horizontal leg 83 of the inner portion 61 of the gasket includes an annular vent panel 89, e.g., adjacent the central hub 63. The vent panel 89 is suitably a region of thinner material. Should pressure rise to an undesirable level within the container 27, the vent panel 89 will break allowing the gas to escape past the gasket 45. Holes (not shown) are formed in the negative terminal plate 53 to allow passage of the gas out of the metal container 27. It is contemplated that other suitable venting arrangements well known to those of ordinary skill in the art may be used without departing from the scope of the present invention.

As seen best in FIG. 3, the inner portion 61 of the gasket 45 further comprises a plurality of guide members 91 formed integrally with the inner portion and extending radially from the central hub 63 to the vertical leg 85 of the inner portion of the gasket. The guide members 91 are suitably configured to taper up and out toward the inner face 87 of the slot 67 formed in the gasket 45, generally at the entry of the slot, to further facilitate guidance of the terminal end 43 of the separator 37 into the slot upon assembly of the cell 21. While the inner portion 61 of the gasket 45 is shown in FIGS. 1-3 as having three such guide members 91, it is contemplated that there may be more or less than three guide members. The annular web 69 connecting the inner and outer portions 61, 65 of the gasket 45 is disposed generally at the upper end of the slot 67 formed between the inner and outer portions and is generally arcuate. However, it is contemplated that the web 69 may be generally straight or otherwise shaped other than arcuate and remain within the scope of this invention.

As shown in FIGS. 1 and 1A, the gasket 45 is sized radially to have an outer diameter that is at least greater than the inner diameter of the lower extent 95 of the container side wall 31, and is more suitably approximately equal to the inner diameter of the upper extent 93 of the container in its open configuration. In a particularly suitable embodiment, the difference between the outer diameter of the gasket 45 and the inner diameter of the lower extent 95 of the container sidewall 31 (i.e., the inner diameter of the container sidewall once the cell 21 is fully assembled in the closed configuration of the container 27) is greater than the width of the slot 67 in the open configuration of the container. However, it is contemplated that the difference between the outer diameter of the gasket 45 and the inner diameter of the lower extent 95 of the container side wall 31 may be equal to or even slightly less than the width of the slot 67 in the open configuration of the container 27 depending on the desired size of the slot following closure of the container to complete assembly of the cell 21.

To assemble the electrochemical cell 21 illustrated in FIGS. 1, 1A and 2, the cathode 35, separator 37 and anode 41 are loaded into the container 27 with the container in its open configuration as shown in FIG. 1. The gasket 45, negative current collector 47 and terminal plate 53 are placed in the open upper end of the container 27 with the gasket seating on the gasket seat formed at the junction of the upper and lower extents 93, 95 of the container and the terminal plate seated on the shoulder 75 formed in the gasket. As the gasket 45 is inserted into the container 27, the terminal end 43 of the separator 37 contacts the tapered guide members 91, 81 of the inner and/or outer portions 61, 63 of the gasket such that the guide members generally direct the separator into the slot formed between the inner and outer gasket portions. The gasket 45 may suitably be rotated through a rotation angle of up to about 120 degrees as it is being placed in the container to further facilitate guidance of the terminal end 43 of the separator 37 along the tapered guide members 91, 81 and into the slot 67.

The upper extent 93 of the container side wall 31 is then bent inward to the closed configuration of the container, thereby bending the outer vertical leg 71 of the outer portion 65 of the gasket 45 over the outer edge of the negative terminal plate 53 to complete the assembly of the cell as shown in FIG. 2. As the upper extent 93 of the container side wall 31 is bent inward, the inner diameter of the upper extent of the container becomes substantially equal to the inner diameter of the lower extent 95 of the container side wall. The upper extent 93 of the container side wall 31 thus applies a compressive (e.g., radially inward) force against the outer portion 65 of the gasket 45 as the side wall diameter decreases. As a result, the gasket 45 generally folds inward at the web 69 connecting the inner and outer portions 61, 63 of the gasket to bring the inner and outer faces 87, 79 of the slot 67 closer together.

In the illustrated embodiment, the inner and outer faces 87, 79 of the slot 67 are sufficiently urged toward each other to pinch the terminal end 43 of the separator 37 therebetween, i.e., with the inner face of the slot in sealing relationship with the inner face of the separator terminal end and the outer face of the slot in sealing relationship with the outer face of the separator terminal end, to thereby seal the terminal end of the separator against contamination between the anode 41 and cathode 35 materials of the cell 21. However, it is contemplated that the inner and outer faces 87, 79 of the slot 67 may be spaced from each other a distance substantially equal to the thickness of the terminal end 43 of the separator 37 (e.g., in general contact with the separator but with little or no pinching of the separator) in the closed configuration of the container 27, or they may be spaced slightly from each other a distance slightly greater than the thickness of the terminal end of the separator in the closed configuration of the container, and still be in sufficiently sealing relationship with the opposite faces of the terminal end of the separator to seal the separator against contamination between the cathode and the anode materials of the cell 21.

Thus, it will be understood that the terms “seal” and “sealing” as used in this embodiment as well as in the other embodiments described herein in reference to sealing of the terminal end of the separator is intended to refer to a seal sufficient to inhibit at least particulate material against passing over the terminal end of the separator from the inner face to the outer face thereof, and may further inhibit liquid against passing over the terminal end of the separator, and still further may inhibit gas against passing over the terminal end of the separator.

While the inner and outer portions 61, 65 (broadly the first and second sealing members) of the gasket 45 (broadly, the sealing assembly) of the illustrated embodiment are hingedly connected by the annular web 69 of the gasket, it is contemplated that the inner and outer portions of the gasket may be formed separate from each other and otherwise free from connection. In such an embodiment, the outer portion 65 would be spaced from the inner portion 61 in the open configuration of the container 27 to define the slot 67 in which the terminal end 43 of the separator 37 is received. Upon closing the container, the outer portion 65 would be moved radially in toward the inner portion 61 to substantially narrower the slot 67 for sealing the terminal end of the separator. It is also understood that while the sealing assembly in accordance with the embodiment shown in FIGS. 1-3 is defined by the gasket 45 that is also used to seal the negative end of the cell 21, the sealing assembly may be instead be defined by one or more components other than the gasket, such as a separate component or components (not shown) disposed between the gasket and the anode 41 and/or cathode 35.

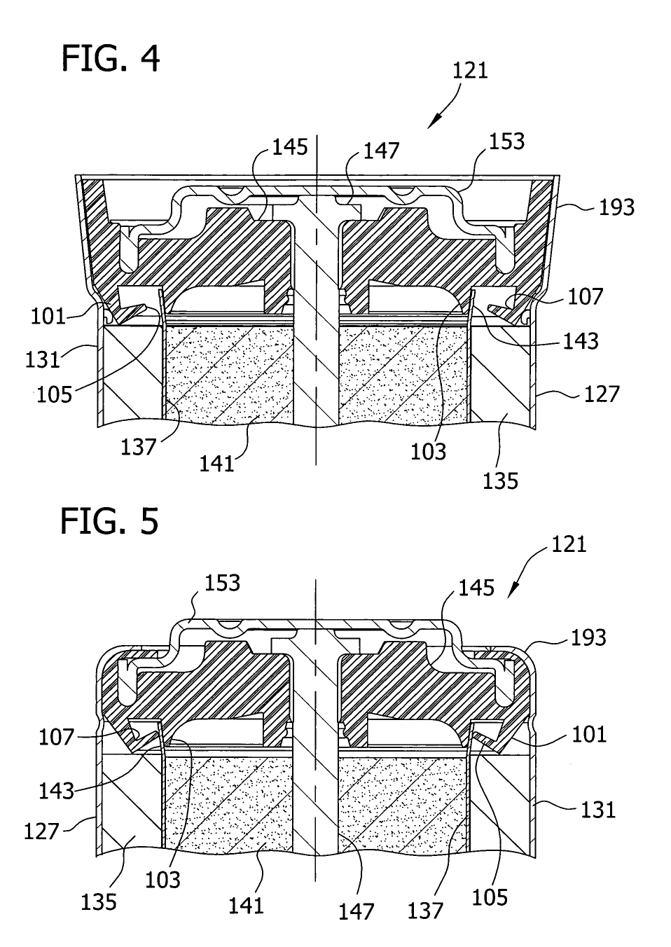

Referring now to FIGS. 4 and 5, in a second embodiment an electrochemical cell 121 generally comprises a container 127, a cathode 135, an anode 141, a separator 137, a negative current collector 147 and a negative terminal plate 153 substantially similar to the embodiment of FIGS. 1 and 2 and described previously. A gasket 145 is also disposed in the container 127 for sealing against the container side wall 131 at the open end of the container. The gasket 145 is generally disk-shaped and has an annular outer flange 101 (broadly, a first sealing member of a sealing assembly according to this second embodiment of the present invention) depending from the gasket suitably radially outward of the terminal end 143 of the separator 137, and an annular inner flange 103 (broadly defining a second sealing member of the sealing assembly of this second embodiment) depending from the gasket suitably radially inward of the terminal end of the separator. In the illustrated embodiment of FIGS. 4 and 5, the annular outer flange 101 is disposed generally at the outermost radial extent of the gasket 145. However, the outer flange 101 may be disposed radially inward of the outermost extent of the gasket 145 and remain within the scope of this invention, as long as the outer flange, and more suitably a free end 105 of the outer flange, is located for positioning radially outward of the terminal end 143 of the separator 137 upon insertion of the gasket into the container 127.

In one embodiment, the gasket 145 (and hence broadly the sealing assembly) is suitably of single-piece construction, such as by being molded from any of the materials from which the gasket 45 of the embodiment of FIGS. 1-3 may be molded. The inner and outer flanges 103, 101 may initially depend straight from the gasket 145, with the outer flange being substantially longer than the inner flange. Before the gasket 145 is inserted into the container 127, such as after initial molding of the gasket, a portion of the outer flange 101 is folded along a fold line 107 to extend in toward the inner flange 103 to reduce the spacing between the inner and outer flanges (but still providing sufficient spacing therebetween for receiving the terminal end 143 of the separator 137 between the inner and outer flanges) as shown in FIG. 4 with the container in its open configuration. As an example, the fold line 107 along which the outer flange 101 is folded corresponds approximately to the bottom of the inner flange 103. However, it is understood that the fold line 107 may be disposed anywhere along the length of the outer flange 101, depending on the length of the outer flange and the desired spacing between the inner and outer flanges 103, 101 after folding of the outer flange. It is also contemplated that the folded configuration of the outer flange 101 may be set upon initial molding of the gasket 127 without departing from the scope of this invention.

Upon closing the upper extent 193 of the container side wall 131 to the closed configuration of the container 127, the outer flange 101 (e.g., the portion connected to the gasket) is urged down against the cathode, such as the fold line 107 of the outer flange, causing the outer flange to bend radially inward generally at the end of the flange fixed to the gasket. It is contemplated that the groove formed in the side wall of the container may also urge the outer flange 101 radially inward. Accordingly, the folded portion of the outer flange 101 (e.g., the free end 105 thereof) is displaced radially further toward the inner flange 103 so that the spacing between the outer flange and the inner flange is less than the thickness of the separator 137 to thereby pinch the terminal end 143 of the separator between the flanges for sealing the terminal end of the separator. It is contemplated that the spacing between the outer flange 101 and the inner flange 103 in the closed configuration of the container 127 may be approximately equal to the thickness of the separator 137 (so as to hold the separator therebetween with little or no pinching of the separator), or slightly greater than the thickness of the separator, and still sufficiently seal the terminal end of the separator within the scope of this invention.

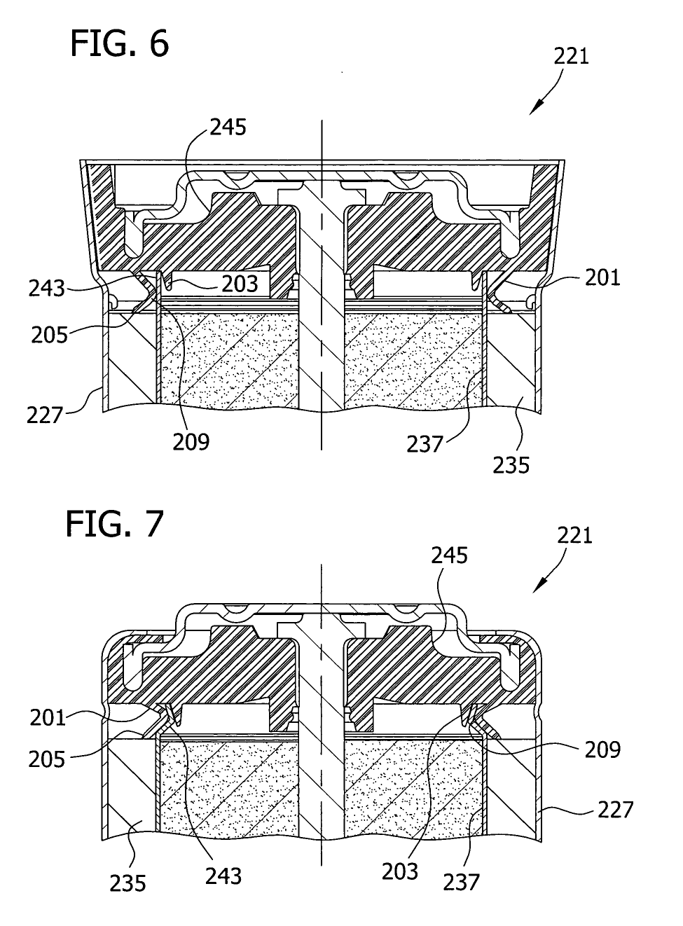

It is also contemplated that the outer flange 101 need not be bent at its fixed connection with the gasket 145 to remain within the scope of this invention. Also, instead of the outer flange 101 being folded inward, or in addition thereto, the inner flange 103 may be folded and/or bent radially outward toward the outer flange without departing from the scope of this invention. It is further contemplated that the outer flange 101 need not be folded to extend the free end 105 of the flange radially inward. For example, in the cell 221 illustrated in FIGS. 6 and 7, a gasket 245 is constructed similar to the gasket 145 of FIGS. 4 and 5, with an annular outer flange 201 (broadly, a first sealing member of a sealing assembly according to a third embodiment of the present invention) depending from the gasket and an annular inner flange 103 (broadly, a second sealing member of the sealing assembly of this third embodiment) depending from the gasket in radially spaced relationship with the inner flange to receive the terminal end 243 of the separator 237 between the flanges. Following initial molding of the gasket 245, the outer flange 201 is bent generally inward at the connection with the gasket and then folded back outward midway along its length so that the outer flange has a generally V-shape upon insertion of the gasket into the container.

As shown in FIG. 6 in the open configuration of the container 227, when the gasket 245 is first inserted into the container the terminal end 243 of the separator 237 is received between the inner flange 203 and an elbow 209 formed by the V-shaped outer flange 201. The free end 205 of the outer flange 201 is disposed above, and may even be in contact with, the cathode 235. Upon closing the container 227 to the closed configuration shown in FIG. 7, the gasket 245 is urged down toward the anode 241 and cathode 235, causing the outer flange 201 to generally collapse (e.g., further fold) between the gasket and the cathode. The elbow 209 formed by the V-shaped outer flange 201 accordingly moves radially in toward the inner flange 203 to pinch the terminal end 243 of the separator 237 between the inner flange and the elbow of the outer flange to thereby substantially seal the terminal end of the separator. It is contemplated that the spacing between the inner flange 203 and the elbow 209 of the outer flange 201 in the closed configuration of the container 227 may instead be approximately equal to the thickness of the separator 237 (so as to hold the separator therebetween with little or no pinching of the separator), or slightly greater than the thickness of the separator, and still sufficiently seal the terminal end 243 of the separator within the scope of this invention.

It is also understood that the terminal end 243 of the separator 237 may be sealed between the elbow 209 of the outer flange 201 and another portion of the gasket 245. For example, the inner flange 203 of the gasket 245 may be omitted and instead the gasket may have a sufficient thickness at an inner portion (not shown) thereof such that the gasket extends down within the container 227 in opposed relationship with the elbow 209 of the outer flange 201.

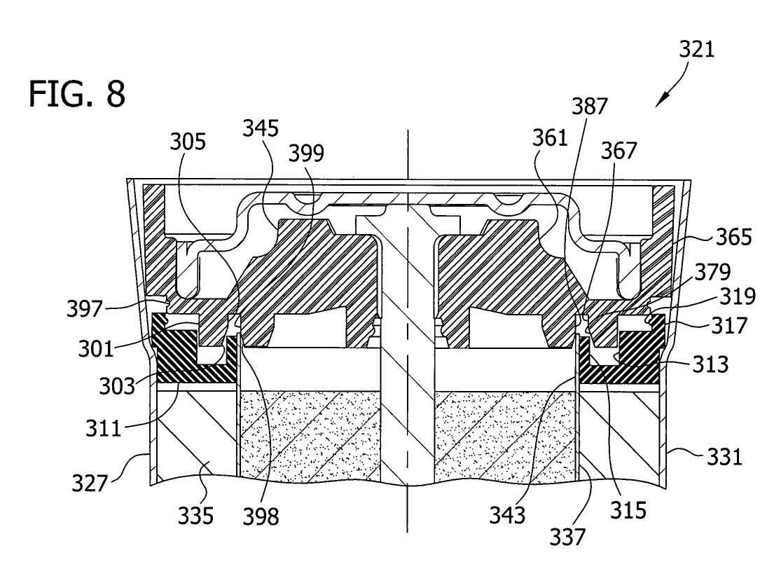

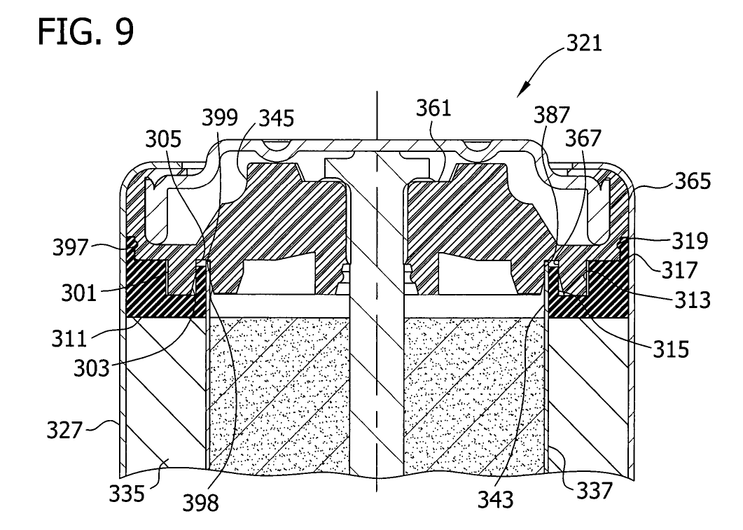

In a fourth embodiment, shown in FIGS. 8 and 9, a sealing assembly for sealing the terminal end 343 of the separator 337 is of a two-piece construction and generally comprises a gasket 345 (broadly, a first sealing member of the sealing assembly) and a gasket seat 311 (broadly, a second sealing member of the sealing assembly) formed separate from the gasket. The gasket seat 311 and gasket 345 may each be formed from any of the materials from which the gasket 45 of the embodiment of FIGS. 1-3 may be formed. The gasket seat 311 and gasket 345 may be formed from the same material as each other, or they may be formed from different materials.

The gasket seat 311 of the illustrated embodiment is annular and is sized in cross-section to seat within the container 327 over the cathode 335, e.g., radially between the sidewall 331 of the container and the terminal end 343 of the separator 337 as shown in FIG. 8 in the open configuration of the container. The gasket seat 311 has an annular channel 313 formed therein to define a radially inner vertical leg 315 of the gasket seat extending vertically in generally opposed relationship with the terminal end 343 of the separator 337. A radially outer vertical leg 317 of the gasket seat 311 extends vertically up from the gasket seat at the radially outermost extent thereof and has an annular rib 319 extending radially inward of the outer vertical leg for positively locating the gasket 345 on the gasket seat as will be described.

The gasket 345 has a slot 367 formed therein for receiving at least the terminal end 343 of the separator 337, and more suitably for together receiving the terminal end of the separator and the inner vertical leg 315 of the gasket seat 311. An inner face 387 of the slot 367 is defined by an annular inner portion 361 of the gasket 345 while an outer face 379 of the slot is defined by an annular outer portion 365 of the gasket. The outer portion 365 of the gasket 345 includes an annular groove 397 sized for receiving the annular rib 319 extending inward from the outer vertical leg 317 of the gasket seat 311, and a depending flange 301 sized for seating within the channel 313 formed in the gasket seat. The outer face 379 of the slot 367 is defined by the depending flange 301 of the outer portion 365 of the gasket 345 and has a lower surface 303 configured to taper upward and in to a vertical upper surface 305 of the slot inner face. As shown in the illustrated embodiment of FIG. 8, the depending flange 301 of the gasket outer portion 365 is radially located on the gasket 345 such that the tapered lower surface 303 is aligned above the inner vertical leg 315 of the gasket seat 311 upon initial placement of the gasket in the container 327, for reasons which will become apparent.

The inner face 387 of the slot 367 defined by the gasket inner portion 361 also has a tapered lower surface 398 and tapers upward and out to a vertical upper surface 399 in opposed relationship with the vertical upper surface 305 of the inner face 387 of the gasket outer portion 365. The radial spacing between the vertical upper surfaces 305, 399 of the inner and outer faces 387, 379 of the slot 367 define a slot width that is suitably narrower than the combined thickness of the terminal end 343 of the separator 337 and the inner vertical leg 315 of the gasket seat 311. The slot width increases at the tapered lower surfaces 303, 398 of the inner and outer faces 387, 379 of the slot 367 to a width greater than the combined thickness of the terminal end 343 of the separator 337 and the inner vertical leg 315 of the gasket seat 311.

In the open configuration of the container shown in FIG. 8, the cathode 335, separator 337 and anode 341 are placed in the container 327 and the gasket seat 311 is then placed in the container over the cathode. The gasket 345 (with the negative current collector 347 and terminal plate 353) is inserted into the container 327 with the flange 301 depending from the gasket outer portion 365 aligned for receipt in the channel 313 formed in the gasket seat 311. The gasket 345 is urged down onto the gasket seat 311 until the annular rib 319 extending inward from the outer vertical leg 317 of the gasket seat snaps into the annular groove 397 formed in the gasket outer portion 365 to secure the gasket and gasket seat together. As the gasket 345 is urged down onto the gasket seat 311, the terminal end 343 of the separator 337 is guided into the gasket slot 367 by the tapered lower surface 398 of the inner face 387 of the slot 367. The inner vertical leg 315 of the gasket seat 311 contacts the tapered lower surface 303 of the outer face 379 of the slot 367. With the slot 367 narrowing toward the vertical upper surfaces 399, 305 of the inner and outer faces 387, 379 of the slot, the tapered lower surface 303 of the outer face 379 of the slot generally radially pinches the inner vertical leg 315 of the gasket seat 311 and the terminal end 343 of the separator 337 within the narrow portion of the slot between the upper surfaces of the inner and outer faces of the slot to generally seal the terminal end of the separator. The container 327 is then closed as shown in FIG. 9 to complete assembly of the cell 321.

It is understood that the width of the slot 367 between the vertical upper surfaces 399, 305 of the inner and outer faces 387, 379 of the slot may instead be approximately equal to, or even slightly greater than, the combined thickness of the terminal end 343 of the separator 337 and the inner vertical leg 315 of the gasket seat 311 in the closed configuration of the container 327 and still sufficiently seal the terminal end of the separator within the scope of the present invention. It is also understood that the snap-fit components of the gasket 345 and gasket seat 211 may be reversed, e.g., with an annular rib (not shown) extending out from the gasket and an annular groove (not shown) formed in the gasket seat 311, or the snap-fit components may be omitted, without departing from the scope of this invention. Also, the annular rib 319 and corresponding annular groove 397 need not be disposed in the outer vertical leg 317 and corresponding gasket outer portion 365 to remain within the scope of this invention.

It is also contemplated that the separator 337, anode, gasket seat 311 and gasket 345 may instead be assembled together outside of the container and then inserted into the container (e.g., with the terminal end 343 of the separator already sealed), i.e., with the anode-filled separator inserted down into the cathode.

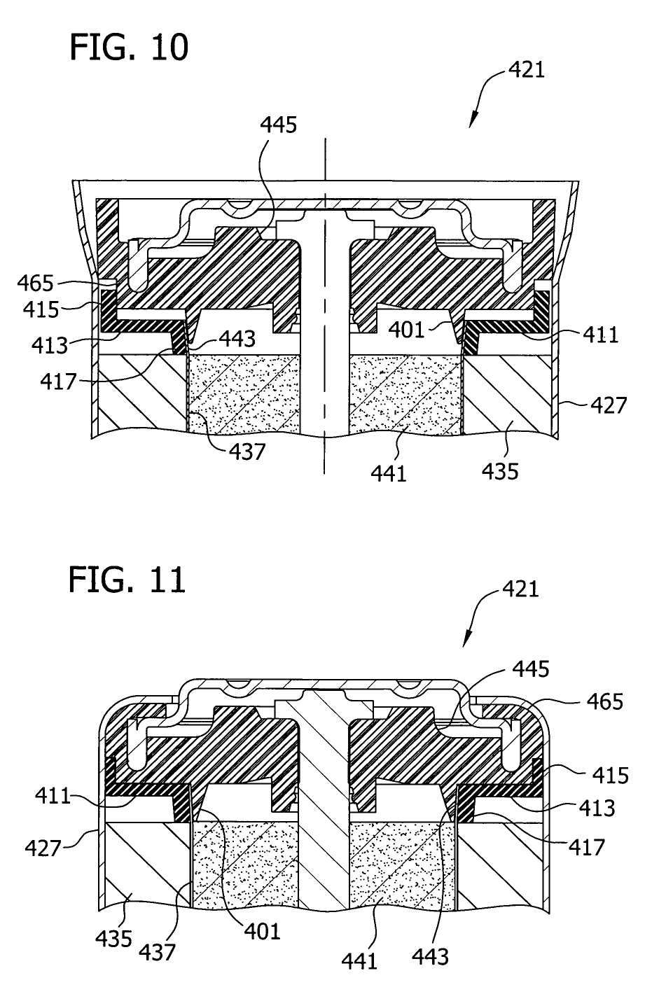

FIGS. 10 and 11 illustrate a fifth embodiment of the present invention in which the sealing assembly is also of a two-piece construction. In this embodiment the sealing assembly comprises an annular gasket seat (broadly, a first sealing member of the sealing assembly), generally indicated at 411, and a generally disk-shaped gasket (broadly, a second sealing member of the sealing assembly, generally indicated at 445. The gasket seat 411 and gasket 445 may each be formed from any of the suitable materials from which the gasket 45 of FIGS. 1-3 may be formed. The gasket seat 411 and gasket 445 may be formed from the same material as each other, or formed from different materials, and remain within the scope of this invention.

The gasket seat 411 of this fifth embodiment is generally Z-shaped in cross-section, having a horizontal segment 413, an outer leg 415 extending up from the horizontal segment and defining the radially outermost extent of the gasket seat, and an inner leg 417 depending from the horizontal segment of the gasket seat. In the illustrated embodiment, the inner leg 417 is slightly angled relative to vertical (e.g., relative to the longitudinal axis of the cell 421) to extend generally inward and down from the horizontal segment 413 of the gasket seat 411. The gasket seat 411 is suitably sized for seating in the container 427 over the cathode 435 with the inner leg 417 in generally opposed relationship with the outer face of the terminal end 443 of the separator 437. The gasket 445 has an annular flange 401 depending generally vertically therefrom at a location corresponding to or slightly inward of the terminal end 443 of the separator 437. An outer portion 465 of the gasket 445 extends generally horizontally relative to the depending flange 401 for seating on the horizontal segment 413 of the gasket seat 411.

To assemble the cell 421, following insertion of the cathode 435, separator 443 and anode 441, the gasket seat 411 is placed in the container 427 with the inner leg 417 of the gasket seat in closely spaced relationship with or even resting on the cathode. The inner leg 417 is suitably in contact with (e.g., abuts against) the terminal end 443 of the separator 437 to support the terminal end of the separator in a generally upright orientation. The gasket 445 is then inserted down into the container 427. In the illustrated embodiment, the flange 401 depending from the gasket 445 is located such that upon insertion of the gasket into the container 427, the flange is disposed generally above a portion of the angled inner leg 417 of the gasket seat 411. As the gasket 445 is urged further into the container 427, the flange 401 depending from the gasket contacts the terminal end 443 of the separator 437 and pinches the terminal end of the separator against the angled inner leg 417 of the gasket seat 411 to substantially seal the terminal end of the separator. The container 427 is then closed in a conventional manner to the closed configuration of the cell 421 as shown in FIG. 11.

It is contemplated that the flange 401 may depend from the gasket 445 at an angle corresponding generally to the angle at which the inner leg 417 depends from the horizontal segment 413 of the gasket seat 411, or that both the flange and the inner leg of the gasket seat may be oriented generally vertically. It is also contemplated that the location of the flange 401 relative to the inner leg 417 of the gasket seat 411 may be such that the terminal end 443 of the separator 437 is retained between the flange and the inner leg of the gasket seat in the closed configuration of the container 427 with little or no pinching of the terminal end of the separator, or the flange may be slightly spaced from the inner leg of the gasket seat in the closed configuration of the container, and still sufficiently seal the terminal end of the separator within the scope of this invention.

It is also contemplated that the separator 437, anode, gasket seat 411 and gasket 445 may instead be assembled together outside of the container 427 and then inserted into the container (e.g., with the terminal end 443 of the separator already sealed), i.e., with the anode-filled separator inserted down into the cathode.

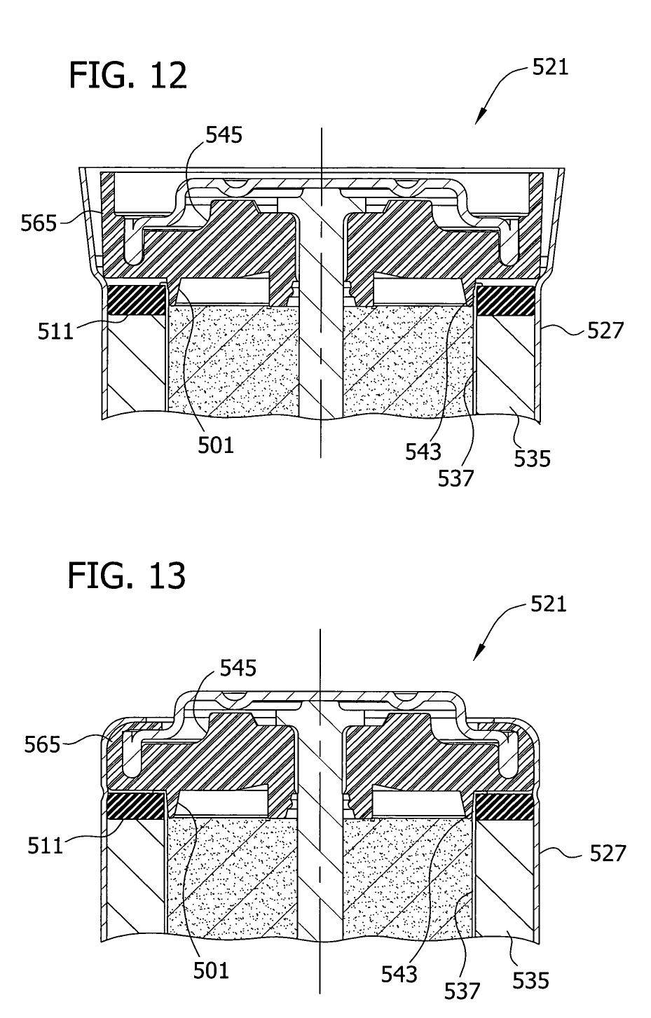

FIGS. 12 and 13 illustrate a sixth embodiment of the present invention in which the cell 521 has a sealing assembly that comprises a washer-shaped gasket seat 511 (broadly, a first sealing member of the sealing assembly) constructed of a compressible material, and a gasket 545 (broadly, a second sealing member of the sealing assembly). The gasket seat 511 is sized for seating over the cathode 535, e.g., radially outward of the separator 537, with an inner surface of the gasket seat adjacent to and in opposed relationship with the terminal end 543 of the separator. The compressible gasket seat 511 is suitably constructed of a resilient, compressible material, and more suitably of a material that is more compressible than the material from which the gasket 545 is constructed. One suitable resilient, compressible material from which the gasket seat 511 may be constructed is an ethylene propylene diene monomer (or a terpolymer). Another suitable gasket seat 511 material is a neoprene butyl rubber. The gasket 545 may be constructed of any of the materials described previously from which the gasket 45 of FIGS. 1-3 may be constructed.

The gasket 545 is also similar to the gasket 445 of the fifth embodiment shown in FIGS. 10 and 11 in that it has a depending flange 501 located for positioning radially inward of the terminal end 543 of the separator 537, and radially outer portion 565 configured for seating on the gasket seat. In the open configuration of the container 527, the gasket seat 511 is placed in the container over the cathode 535, with the terminal end 543 of the separator 537 generally adjacent to and more suitably supported by the inner surface of the gasket seat. The gasket 545 is inserted into the container 527 with the depending flange 501 in opposed relationship with the inner surface of the terminal end 543 of the separator 537 to hold the separator between the flange and the gasket seat 511.

Upon closing the container 527 as shown in FIG. 13, the outer portion 565 of the gasket 545 is urged down against the gasket seat 511 and compresses the gasket seat. Compressing the gasket seat 511 in this manner tends to displace the gasket seat material radially (e.g., it expands outward) such that the width of the gasket seat increases. As a result, the radially inner surface of the gasket seat 511 urges the terminal end 543 of the separator 537 toward the flange 501 depending from the gasket 545 to pinch the terminal end of the separator between the flange and the gasket seat. It is contemplated that the positioning of the flange 501 relative to the radially inner surface of the gasket seat 511 may be such that the terminal end 543 of the separator 537 is retained between the flange and the inner surface of the compressed gasket seat in the closed configuration of the container 527 with little or no pinching of the terminal end of the separator, or the flange may be slightly spaced from the inner surface of the compressed gasket seat in the closed configuration of the container, and still sufficiently seal the terminal end of the separator within the scope of this invention.

It is also contemplated that the separator 537, anode, gasket seat 511 and gasket 545 may instead be assembled together outside of the container 527 and then inserted into the container (e.g., with the terminal end 543 of the separator already sealed), i.e., with the anode-filled separator inserted down into the cathode.

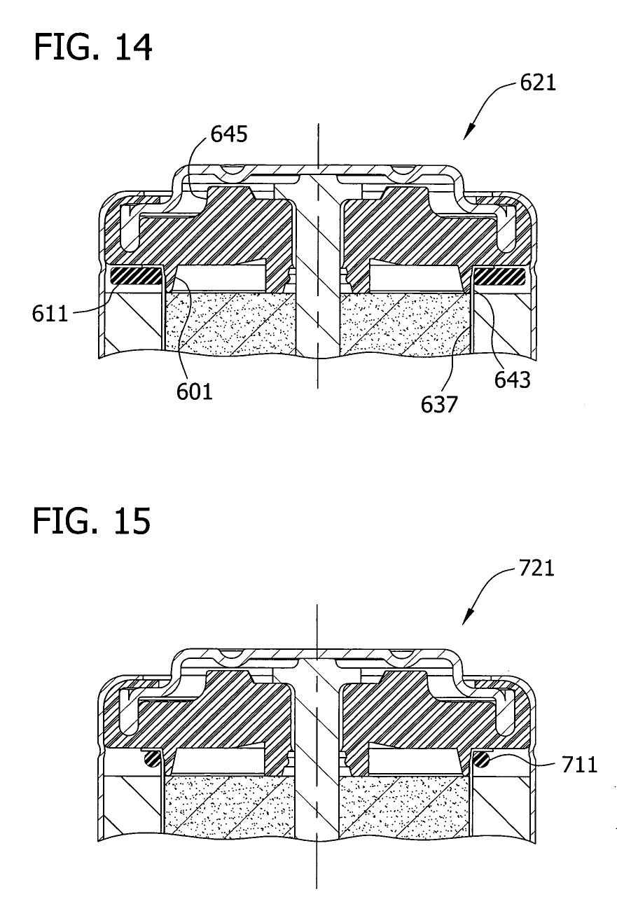

In a seventh embodiment of the present invention, shown in FIG. 14, the sealing assembly of a cell 621 generally comprises an annular elastomeric member 611 (broadly, a first sealing member of the sealing assembly), and a gasket 645 (broadly, a second sealing member of the sealing assembly). The gasket 645 may be constructed of any of the materials described previously from which the gasket 45 of FIGS. 1-3 may be constructed. The gasket 645 is suitably similar to the gasket 545 of the fifth embodiment shown in FIGS. 10 and 11 in that it has a depending flange 601 located for positioning radially inward of the terminal end 643 of the separator 637.

The elastomeric member 611 is suitably constructed of an elastically stretchable and contractible material and sized for circumscribing the flange 601 depending from the gasket 645. More suitably, the elastomeric member 611 is placed around the flange 601 while in an elastically stretched condition so that upon release of the elastomeric member it elastically contracts radially to pinch the terminal end 643 of the separator 637 between the gasket flange 601 and the elastomeric member. In the illustrated embodiment of FIG. 14, the elastomeric member 611 is generally washer-shaped. As another example, illustrated in FIG. 15 as an eighth embodiment of the present invention, the elastomeric member 711 incorporated in cell 721 is shaped generally as an O-ring.

It is also contemplated that the separator 637, anode, elastomeric member 611 or 711 and gasket 645 may instead be assembled together outside of the container 627 and then inserted into the container (e.g., with the terminal end 643 of the separator already sealed), i.e., with the anode-filled separator inserted down into the cathode.

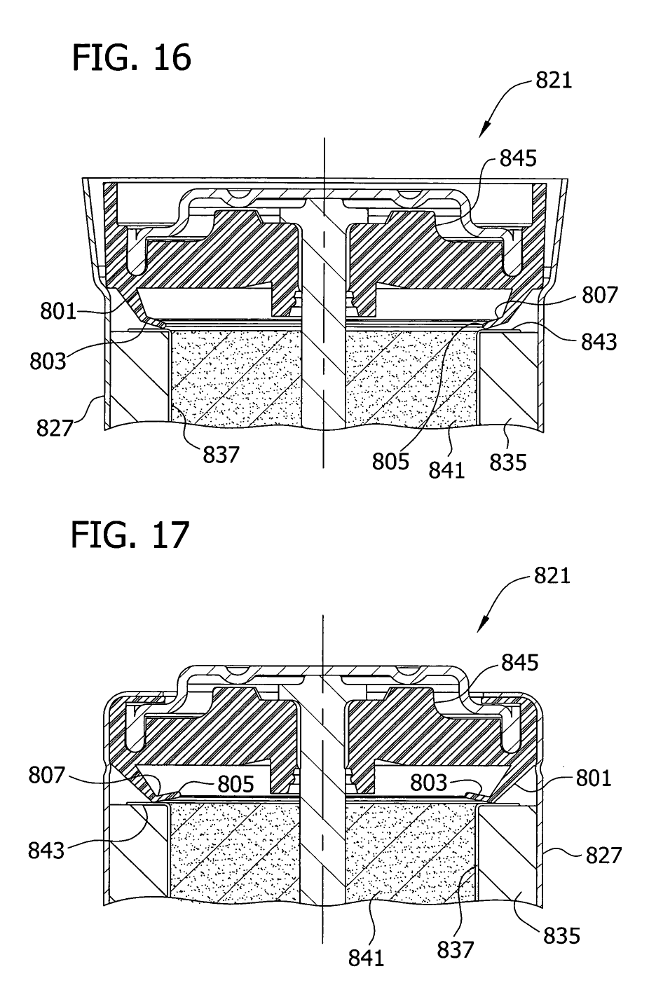

Referring now to FIGS. 16 and 17, a cell 821 has a sealing assembly in accordance with a ninth embodiment of the present invention comprises a gasket 845 (broadly, a sealing member) that is generally disk-shaped and has a flange 801 depending therefrom for positioning radially outward of the terminal end 843 of the separator 837, and more suitably depends from the gasket adjacent the outermost radial extent of the gasket. The gasket 845 is suitably of a single-piece construction and may be constructed of any of the materials from which the gasket 45 illustrated in FIG. 1 and described previously may be constructed. In one embodiment, the flange 801 is initially formed to depend straight down from the gasket 845. Before the gasket 845 is inserted into the container 827 (e.g., after initial molding of the gasket), a lower portion 803 of the flange 801 depending from the gasket is folded to extend generally radially inward.

In the embodiment shown in FIG. 16, the flange 801 depending from the gasket 845 is also bent slightly radially inward generally at the fixed (e.g., top) end of the flange. In this bent and folded orientation, the free end 805 of the flange extends radially inward beyond the terminal end 843 of the separator 837 in the open configuration of the container 827. It is understood that the fold line 807 along which the flange 801 is folded may be located generally anywhere along the length of the flange, depending on the length of the flange and the radial location from which the flange depends from the gasket relative to the radial location of the terminal end 843 of the separator 837.

Upon closing the container 827, as shown in FIG. 17, the gasket 845 is urged further into the container toward the anode 841 and cathode 835. The bent and folded flange 801 depending from the gasket 845 pinches the terminal end of the separator 837 against the cathode 835 to substantially seal the terminal end 843 of the separator. It is contemplated that instead of the flange 801 being folded inward, the flange may depend from the gasket 845 at a location radially inward of the terminal end 843 of the separator 837 and be bent and/or folded radially outward to pinch the terminal end of the separator against the cathode 835 in the closed configuration of the container 827. It is also contemplated that the flange 801 may be located and configured to instead pinch the terminal end 843 of the separator 837 against the anode 841 for sealing between the flange 801 and the anode and remain within the scope of this invention.

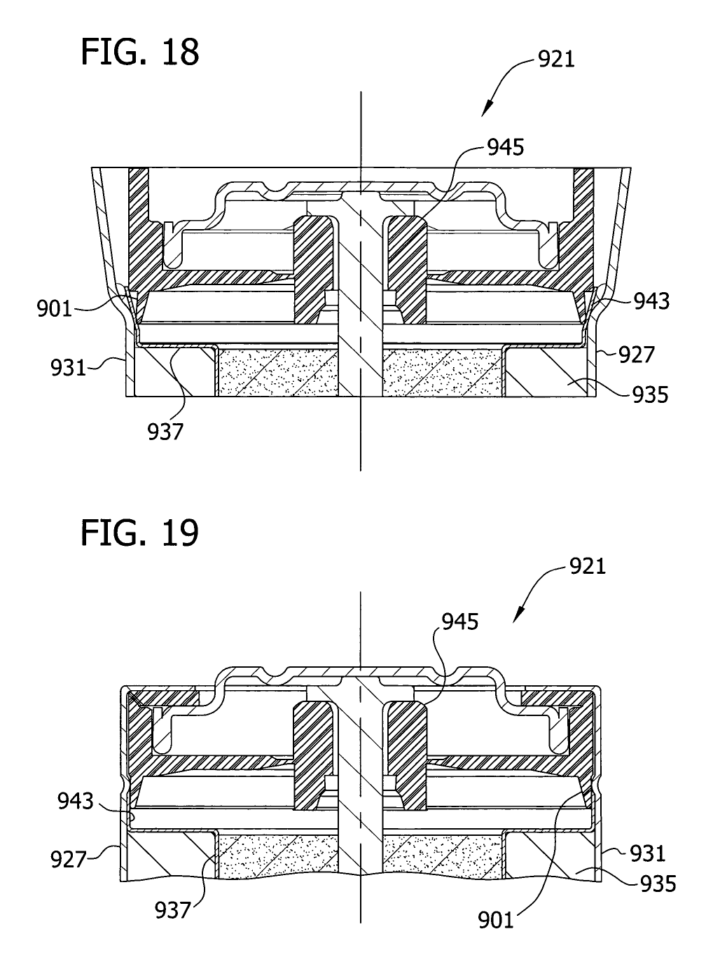

FIGS. 18 and 19 illustrate a tenth embodiment of a sealing assembly comprising a generally disk-shaped gasket 945 (broadly, a sealing member) having an annular flange 901 depending therefrom generally adjacent the radially outermost extent of the gasket. In this embodiment, the terminal end 943 of the separator 937 is sufficiently sized in length so that in the open configuration of the container 927 of the cell 921, the terminal end of the separator can be generally folded to extend radially outward over the cathode 935 and then up along the container side wall 931 in opposed relationship with the flange 901 depending from the gasket 945. Upon closing the container 927, the container side wall 931 urges the upward extending portion of the terminal end 943 of the separator 937 inward against the flange 901 to pinch the separator between the container and the gasket flange. It is contemplated that the radial location of the flange 901 relative to the side wall 931 of the container 927 in the open configuration thereof may be such that the terminal end 943 of the separator 937 is retained between the flange and the container sidewall in the closed configuration of the container with little or no pinching of the terminal end of the separator, or the flange may be slightly spaced from the container sidewall in the closed configuration of the container, and still sufficiently seal the terminal end of the separator within the scope of this invention.

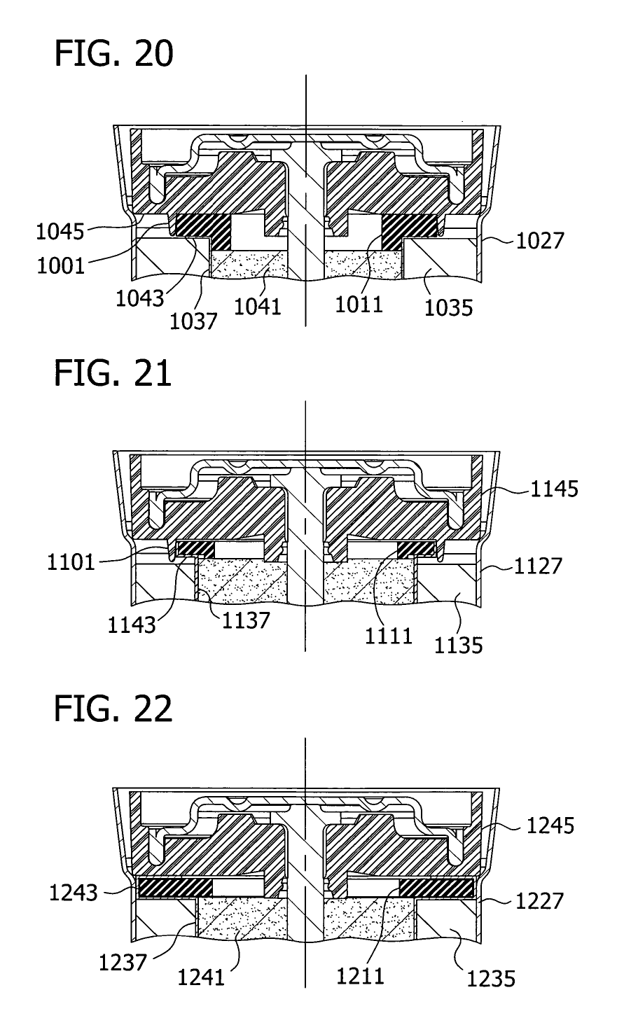

FIGS. 20-22 illustrate additional embodiments of the present invention similar to the embodiment of FIGS. 12 and 13 in that the sealing assembly comprises a generally washer-shaped gasket seat (broadly, a first sealing member of the sealing assembly) constructed of a compressible material, and a gasket (broadly, a second sealing member of the sealing assembly). In FIG. 20, the gasket 1045 has a flange 1001 depending therefrom at a location for positioning generally radially outward of the terminal end 1043 of the separator 1037. The gasket seat 1011 (broadly a sealing member of a sealing assembly of the embodiment of FIG. 20) is sized for seating over the anode 1041, the terminal end 1043 of the separator 1037 and a portion of the cathode 1035, with the terminal end of the separator disposed between the gasket seat and the cathode. The gasket 1045 is placed on the gasket seat 1011 in the open configuration of the container 1027 with the depending flange 1001 extending along the outer sidewall of the gasket seat. Upon closing the container 1027 (the closed configuration is not shown), the gasket 1045 urges the gasket seat 1011 toward the anode 1041 and cathode 1035 to pinch the terminal end 1043 of the separator 1037 between the gasket seat and the cathode.

The embodiment of FIG. 21 is similar to the embodiment of FIG. 20, but with the terminal end 1143 of the separator 1137 being sized to fold generally radially out and up between the gasket seat 1111 and the flange 1101 depending from the gasket 1145. The gasket seat 1111 is shown as being spaced above the cathode 1135. Accordingly, upon closing the container 1127, the gasket 1145 urges the compressible gasket seat 1111 against the anode. Compression of the gasket seat causes the gasket seat to expand radially against the flange depending from the gasket to pinch (e.g., compress) the terminal end of the separator between the gasket seat and the flange. It is contemplated that the gasket seat may additionally seat against the cathode to further pinch the terminal end of the separator between the gasket seat and the cathode without departing from the scope of this invention. It is also contemplated that the separator 1137, anode, gasket seat 1111 and gasket 1145 may instead be assembled together outside of the container 1127 and then inserted into the container (e.g., with the terminal end 1143 of the separator already sealed), i.e., with the anode-filled separator being inserted down into the cathode.

In the illustrated embodiment of FIG. 22, the gasket 1245 does not have a depending flange. The gasket seat 1211 is sized to extend radially outward over a portion of the anode 1241 (e.g., radially inward of the cathode 1235 and the portion of the separator 1237 disposed between the anode and cathode), and outward over the cathode to generally adjacent the container sidewall. The terminal end 1243 of the separator 1237 is sufficiently sized for folding radially outward over the cathode 1235 and then up between the container sidewall and the gasket seat 1211. Upon closing the container 1227 (the closed configuration is not shown), the gasket 1245 urges the compressible gasket seat 1211 toward the anode 1241 and cathode 1235. Compression of the gasket seat 1211 causes the gasket seat to expand radially toward the container sidewall to pinch the terminal end 1243 of the separator 1237 between the gasket seat and the container sidewall.

It is contemplated that a sealant (not shown) may be used in any of the embodiments shown in the drawings and described herein to further seal the terminal end of the separator, and more suitably to further seal the terminal end of the separator against liquid leaking over the terminal end of the separator. For example, in the embodiment illustrated in FIGS. 1-3, a sealant (not shown) may be provided in the slot 67 to further seal the terminal end 43 of the separator 37 within the slot. In other embodiments such as the embodiments illustrated in FIGS. 16-19, the sealant (not shown) may be provided at the terminal end of the separator between the sealing assembly and the cathode (FIGS. 16-17) or between the sealing assembly and the container (FIGS. 18-19) to further seal the terminal end of the separator.

In one embodiment the sealant may be a generally non-adhesive sealant. Examples of known, suitable sealants include, but are not limited to, bitumen in a hydrocarbon solvent (benzene), polyamide in a hydrocarbon solvent (toluene) and chlorosulfonated polyethylene in hydrocarbon solvent (toluene). In other embodiments, an adhesive sealant may be used. Suitable adhesive sealants are disclosed in co-pending application Serial No. ______ (attorney docket no. RAYO 9214), entitled ADHESIVE FOR USE IN AN ELECTROCHEMICAL CELL and filed Feb. 15, 2005, the entire disclosure of which is incorporated herein by reference.

When introducing elements of the present invention or the various versions, embodiment(s) or aspects thereof, the articles “a”, “an”, “the” and “said” are intended to mean that there are one or more of the elements. The terms “comprising”, “including” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above without departing from the scope of the invention, it is intended that all matter contained in the above description and shown in the accompanying drawings shall be interpreted as illustrative and not in a limiting sense.

What is claimed is:

1. An electrochemical cell comprising:
a cathode;
an anode;
a container having a sidewall defining an interior of the container, the cathode and the anode being disposed in the container, said container defining a longitudinal direction and a transverse direction of the cell;
a separator disposed in the container between the cathode and the anode, the separator having a terminal end extending longitudinally outward from between the cathode and the anode, said terminal end of the separator having a first face and a second face opposite the first face;
a negative current collector disposed in the container in contact with the anode; and
a sealing assembly for sealing the terminal end of the separator, the sealing assembly being formed separate from the cathode, the anode and the container and comprising a first sealing member in sealing relationship with the first face of the terminal end of the separator and a second sealing member in sealing relationship with the second face of the terminal end of the separator to thereby seal said terminal end of the separator.

2. The electrochemical cell of claim 1 wherein the terminal end of the separator is pinched between said first and second sealing members of the sealing assembly.

3. The electrochemical cell of claim 1 wherein the sealing assembly is of a single-piece construction.

4. The electrochemical cell of claim 1 wherein the sealing assembly is further configured for sealing engagement with the side wall of the container.

5. The electrochemical cell of claim 1 wherein the second sealing member of the sealing assembly is in transversely spaced relationship with the first sealing member of said sealing assembly within the container to define a slot between said first and second sealing members, the terminal end of the separator being received in the slot between said first and second sealing members.

6. The electrochemical cell of claim 5 wherein at least one of the first and second sealing members is moveable transversely relative to the other one of the first and second sealing members to facilitate sealing of the separator terminal end within the slot between the first and second sealing members of the sealing assembly.

7. The electrochemical cell of claim 6 wherein the sealing assembly is of a single-piece construction.

8. The electrochemical cell of claim 7 wherein the sealing assembly further comprises a web extending transversely between and hingedly connecting the first and second sealing members of the sealing assembly to permit hinged movement of said sealing members transversely relative to each other.

9. The electrochemical cell of claim 8 wherein the sealing assembly comprises a gasket having an inner portion defining said first sealing member and an outer portion defining said second sealing member, said outer portion of the gasket being spaced transversely from said inner portion, said web extending transversely between and hingedly connecting the inner portion and outer portion of the gasket, the outer portion of the gasket being in sealing engagement with the container sidewall.

10. The electrochemical cell of claim 9 wherein at least a portion of the container sidewall has a first transverse dimension in an open configuration of the container and a second transverse dimension less than said first transverse dimension in a closed configuration of the container, in the open configuration of the container the gasket having a transverse dimension greater than the second transverse dimension of said container sidewall portion such that the gasket is compressed transversely upon configuring the container to its closed configuration to move the outer portion of the gasket transversely toward the inner portion thereof.

11. The electrochemical cell of claim 5 wherein at least one of the first and second sealing members of the sealing assembly comprises at least one guide member, said at least one guide member having a surface generally facing the terminal end of the separator and tapering into the slot between the first and second sealing members to facilitate guidance of the terminal end of the separator into said slot upon assembly of the cell.

12. The electrochemical cell of claim 10 wherein each of the first and second sealing members of the sealing assembly comprises a plurality of said guide members.

13. The electrochemical cell of claim 11 wherein the cell is configurable between an open configuration for initial assembly of the cell, and a closed configuration, the second sealing member of the sealing assembly being in transversely spaced relationship with the first sealing member of said sealing assembly within the container such that the terminal end of the separator is received therebetween, at least one of the first and second sealing members being bendable upon configuring of the cell to its closed configuration to move said at least one of the first and second sealing members transversely relative to the other one of said first and second sealing members to sealingly retain said terminal end of the separator between said first and second sealing members in the closed configuration of the cell.

14. The electrochemical cell of claim 10 wherein the second sealing member comprises a first flange member depending from the gasket in transversely spaced relationship with the first sealing member, the first flange member being bendable upon configuring of the container to its closed configuration to move said flange member transversely toward said first sealing member to sealingly retain said terminal end of the separator between said flange member and said first sealing member in the closed configuration of the container.

15. The electrochemical cell of claim 14 wherein the first sealing member comprises a second flange member depending from the gasket in transversely spaced relationship with the first flange member.

16. The electrochemical cell of claim 1 wherein the second sealing member comprises a continuous elastic sealing member substantially surrounding at least a portion of the first sealing member in opposed relationship with the second face of the terminal end of the separator, the elastic sealing member being in a generally stretched condition about said portion of the first sealing member to apply a transversely directed biasing force to the second face of the terminal end of the separator to thereby pinch the terminal end of the separator between the elastic sealing member and the first sealing member.

17. The electrochemical cell of claim 16 wherein the first sealing member comprises a gasket configured for sealing engagement with the container sidewall, the elastic sealing member substantially surrounding at least a portion of the gasket to pinch the terminal end of the separator between the elastic sealing member and the gasket.

18. The electrochemical cell of claim 17 wherein the gasket has a flange member depending therefrom for opposed relationship with the first face of the terminal end of the separator, the elastic sealing member surrounding said flange member to pinch the separator terminal end between the elastic sealing member and the gasket flange member.

19. The electrochemical cell of claim 1 further comprising a sealant at said terminal end of the separator to further seal said separator terminal end.

20. The electrochemical cell of claim 19 wherein the sealant is an adhesive sealant.

21. The electrochemical cell of claim 1 wherein the first sealing member comprises a compressible member disposed within the container in generally sealing relationship with the first face of the terminal end of the separator, the second sealing member comprising a gasket disposed within the container for sealing engagement with the container sidewall, the gasket being in sealing relationship with the second face of the terminal end of the separator.

22. The electrochemical cell of claim 21 wherein the gasket applies a compressive force to the compressible member in the longitudinal direction of the cell to pinch the separator terminal end in the transverse direction of the cell between the compressible member and the gasket.

23. The electrochemical cell of claim 21 wherein the gasket has a flange depending therefrom, said flange being in sealing relationship with the second face of the terminal end of the separator.

24. An electrochemical cell comprising:
a cathode;
an anode;
a container having a sidewall defining an interior of the container, the cathode and the anode being disposed in the container, said container defining a longitudinal direction and a transverse direction of the cell;
a separator disposed in the container between the cathode and the anode, the separator having a terminal end extending longitudinally outward from between the cathode and the anode, said terminal end of the separator having a first face and a second face opposite the first face;
a negative current collector disposed in the container in contact with the anode; and
a sealing assembly for sealing the terminal end of the separator, the sealing assembly being configured and arranged within the container to seal the terminal end of the separator between the sealing assembly and at least one of the cathode, the anode and the container with said first face of the terminal end of the separator in sealing relationship with the sealing assembly and the second face of the terminal end of the separator in sealing relationship with said at least one of the cathode, the anode and the container.

25. The electrochemical cell of claim 24 wherein the terminal end of the separator is pinched between said sealing assembly and said at least one of the cathode, the anode and the container.

26. The electrochemical cell of claim 24 wherein the sealing assembly is further configured for sealing engagement with the sidewall of the container.

27. The electrochemical cell of claim 24 wherein the container is configurable from an open configuration which facilitates assembly of the anode, cathode, collector and sealing assembly in the container, to a closed configuration, the sealing assembly comprising a gasket disposed longitudinally in the container relative to the anode and the cathode and having a flange member depending therefrom to extend at least in part longitudinally within the container, in the closed configuration of the container the terminal end of the separator being sealed between the flange member and said at least one of the anode, the cathode and the container.

28. The electrochemical cell of claim 27 wherein the flange member is transversely positioned in the container in generally longitudinally opposed relationship with the cathode, the flange member being bendable relative to the gasket to permit transverse movement of the flange member relative to the gasket upon configuring of the container to its closed configuration to seal the terminal end of the separator between the flange member and the cathode.

29. The electrochemical cell of claim 28 wherein the flange member has a first portion having an end fixed to the gasket, and a second portion folded relative to the first portion to facilitate transverse movement of the flange member relative to the gasket upon configuring of the container to its closed configuration.

30. The electrochemical cell of claim 27 wherein the gasket is further configured for sealing engagement with the sidewall of the container.

31. The electrochemical cell of claim 27 wherein the flange member is transversely positioned in the container and has an outer face in generally opposed relationship with the container sidewall, the terminal end of the separator being sealed between the outer face of the flange member and the container sidewall in the closed configuration of the container.

32. The electrochemical cell of claim 31 wherein the terminal end of the separator extends transversely over the cathode to adjacent the container sidewall and then generally longitudinally to between the outer face of the flange member and the container sidewall.

33. The electrochemical cell of claim 24 wherein the sealing assembly comprises a compressible member disposed within the container in generally sealing relationship with the first face of the terminal end of the separator, in a closed configuration of the container the terminal end of the separator being sealed between the compressible member and the cathode with the second face of the terminal end of the separator in sealing relationship with the cathode.

34. The electrochemical cell of claim 33 wherein the compressible member is configured and arranged in the container for compression generally in the longitudinal direction of the cell in the closed configuration of the container, said compression pinching the separator terminal end between the compressible member and the cathode.

35. The electrochemical cell of claim 33 further comprising a gasket disposed within the container for sealing engagement with the container sidewall in the closed configuration of the container, said gasket applying a compressive force to the compressible member in the longitudinal direction of the cell in the closed configuration of the container, said compression pinching the terminal end of the separator between the compressible member and the cathode.

36. The electrochemical cell of claim 24 wherein the sealing assembly comprises a compressible member disposed within the container in sealing relationship with the first face of the terminal end of the separator, the second face of the terminal end of the separator being in sealing relationship with the container sidewall whereby in a closed configuration of the container the terminal end of the separator is sealed between the compressible member and the container sidewall.

37. The electrochemical cell of claim 36 wherein the compressible member is configured and arranged in the container for compression generally in the longitudinal direction of the cell in the closed configuration of the container, the compressible member further being adapted for expansion in the transverse direction upon compression in the longitudinal direction, said expansion in the transverse direction pinching the separator terminal end between the compressible member and the container sidewall.

38. The electrochemical cell of claim 24 wherein the sealing assembly comprises a compressible member disposed within the container in generally sealing relationship with the first face of the terminal end of the separator, and a gasket disposed within the container for sealing engagement with the container sidewall in a closed configuration of the container, the second face of the terminal end of the separator being in sealing relationship with the gasket in the closed configuration of the container.

39. The electrochemical cell of claim 38 wherein the gasket applies a compressive force to the compressible member in the longitudinal direction of the cell in the closed configuration of the container to pinch the terminal end of the separator in the transverse direction of the cell between the compressible member and the gasket.

40. The electrochemical cell of claim 38 wherein the gasket has a flange depending therefrom, the second face of the terminal end of the separator being in sealing relationship with said flange in the closed configuration of the container.

41. An electrochemical cell comprising:
a generally cylindrical container having a sidewall defining an interior of the container, said container further defining a longitudinal direction and a radial direction of the cell;
a generally annular cathode extending longitudinally within the container,
a tubular separator extending longitudinally within the cathode to define an interior thereof;
an anode disposed within the interior of the separator such that the separator separates the cathode from the anode, the separator having a terminal end extending out from between the cathode and the anode, a radially inner face and a radially outer face opposite the inner face;
a negative current collector disposed in the container in contact with the anode; and
a sealing assembly for sealing the terminal end of the separator, the inner and outer faces of the terminal end of the separator being pinched between at least a portion of the sealing assembly and at least one of another portion of the sealing assembly, the anode, the cathode and the container sidewall.

42. The electrochemical cell of claim 41 wherein the sealing assembly comprises a generally annular inner portion facing the inner face of the terminal end of the separator and a generally annular outer portion disposed radially outward of said inner portion and facing the outer face of the terminal end of the separator, the inner and outer faces of said terminal end of the separator being pinched between said inner and outer portions of the sealing assembly.

43. The electrochemical cell of claim 42 wherein the sealing assembly is of a single-piece construction.

44. The electrochemical cell of claim 41 wherein the sealing assembly is in sealing engagement with the container sidewall.

45. The electrochemical cell of claim 41 further comprising a gasket formed separate from the sealing assembly and disposed in sealing engagement with the container sidewall, the sealing assembly being disposed generally longitudinally between the gasket and at least a portion of the cathode.

46. The electrochemical cell of claim 45 wherein the sealing assembly is compressible and is compressed between the gasket and the cathode.

47. The electrochemical cell of claim 41 wherein the sealing assembly comprises a first sealing member in opposed relationship with the inner face of the terminal end of the separator and a second sealing member formed separate from the first sealing member and disposed in opposed relationship with the outer face of the terminal end of the separator, the inner and outer faces of the terminal end of the separator being pinched between the first and second sealing members.

48. The electrochemical cell of claim 47 wherein the first and second sealing members are releasably interlocked.

49. A method for making an electrochemical cell of the type comprising a container having a sidewall defining an interior thereof, an anode disposed in the container, a cathode disposed in the container, and a separator disposed in the container between the anode and cathode and having a terminal end extending out from between the anode and the cathode and having a first face and a second face opposite the first face, the method comprising:
inserting the cathode into the container;
configuring the separator to define an interior thereof receiving the anode;
inserting the anode into the interior of the separator, the anode filling less than the entire interior of the separator to define a terminal end of the separator that is unfilled by the anode, the terminal end having a first face and a second face opposite the first face;
positioning a sealing assembly at the terminal end of the separator to seal said terminal end whereby the sealing assembly, the separator and the anode are held in assembly with each other for insertion into the container; and
inserting the sealing assembly, separator and anode into the container with the separator separating the anode from the cathode and the terminal end of the separator extending out from between the anode and cathode and sealed by said sealing assembly.
